(19) United States
(12) Patent Application Publication
(10) Pub. No.: US 2019/0215589 A1
(43) Pub. Date: Jul. 11, 2019

(54) ULTRA-LIGHT, MULTIPLE-USE AND SUSTAINABLE DIRECTIONAL ACOUSTIC BOX

(71) Applicant: Aurélio MAYORCA, JOINVILLE (BR)

(72) Inventor: Aurélio MAYORCA, JOINVILLE (BR)

(21) Appl. No.: 16/323,735

(22) PCT Filed: Jul. 14, 2017
(86) PCT No.: PCT/BR2017/050188

§ 371 Date: Feb. 6, 2019

(30) Foreign Application Priority Data
Jul. 22, 2016 (BR) 10 2016 017020-6

(51) Int. Cl. H04R 1/02

(52) U.S. Cl. CPC H04R 1/025

(57) ABSTRACT

The present application to an invention relates to a device that allows sound-generating appliances and loudspeakers to be placed inside the acoustic box, improving their sound and allowing an innovative acoustic box to be produced, with excellent sound quality, at a low cost, ensuring the interchangeability, transportability, beauty, lightness, durability and sustainability of the equipment.

The present invention patent deals with o group of arrangements which facilitate the manufacture of a high performance acoustic box at a low cost of manufacturing. This is counter to modern sound equipment, micro acoustix boxes, cellular phones and other equipment that reproduces sound.

At the same time, the “ULTRA-LIGHT, MULTI-PURPOSE AND SUSTAINABLE, DIRECTIONAL ACOUSTIC BOX”, had its discovery after the study of main physicists involved (sound, vibration, frequencies, reverberations, resonance and harmonics, economy and sustainability). Being that, after exhaustive testing, and measurements, we were able to project acoustic arrangements, functional designs and walls of rigid materials (predominantly sheets of steel or similar, or the so called “Flanders sheets of steel”, galvanized or another form of analogous coating), which allowed the conception of an industrialized product which is the object of the present invention patent.

The “ULTRA-LIGHT, MULTIPURPOSE AND SUSTAINABLE DIRECTIONAL ACOUSTIC BOX” brings some innovations such as: it can be manufactured with or without speakers and amplifier module being that if it is manufactured without the speaker, it uses the speaker of the generator equipment of sound like cellular phones, micro-amplifiers, pocket radios, sound systems (which is what small acoustic micro-box with their own batteries and/or electricity from the network, with a radio, pendrive connection/Bluetooth, they fit in a pocket or in a purse, there are diverse sizes) or any other sound generating equipment.

The present invention patent can also be used to improve the sound from speakers from residential and commercial alarms systems by merely placing the speaker inside the “ULTRA-LIGHT, MULTI-PURPOSE AND SUSTAINABLE DIRECTIONAL ACOUSTIC BOX” (placing the speaker or sound generator equipment, means to affix it to the inside of the present invention patent being lower, or merely easily support it so that it can be quickly removed), being that the box is manufactured at a low cost which avoids the occurrence of theft or vandalism of the speaker and the acoustic box, being that it turns it into a substitute of any component much more easily and its placement in the environment is equally simplified.

Besides what was mentioned above, the “ULTRA-LIGHT, MULTIPURPOSE AND SUSTAINABLE DIRECTIONAL ACOUSTIC BOX” brings some other innovations such as in the construction of internal walls, it is preferable to use metallic sheets such as Flanders Sheets or similar items, which in the present invention supply excellent performance, they can also be used as external finishings and decoration for metallography and are obtained taking advantage of the scraps that are left over from the automobile or home appliance industries, as well as maintenance cans and other items which provide high fidelity sound, lightweight, durable, portable, are beautiful and sustainable.

Another point that stands out is the fact that in the “ULTRA-LIGHT, MULTIPURPOSE AND SUSTAINABLE DIRECTIONAL ACOUSTIC BOX” the speakers, radio, cellular phone, complete sound systems or deck recording systems (amplified acoustic micro-boxes) and other sound generating equipment, are placed in the box, because placing the speakers inside the box, you obtain a different sound, augmented and improved.

Last but not least as an important differential, the potency of the sounds (watts), its amplitude (in dB) and its average frequencies, will determine the size of the box and its opening for the sound, overall, there are many ranges of frequencies and potential for use, allowing it to be used in various types of sound generating equipment and speakers.

In the models on the market today, the speaker is placed outside of the box, with it frontal cone outside of the box and only the sound behind the cone is placed inside of the box.

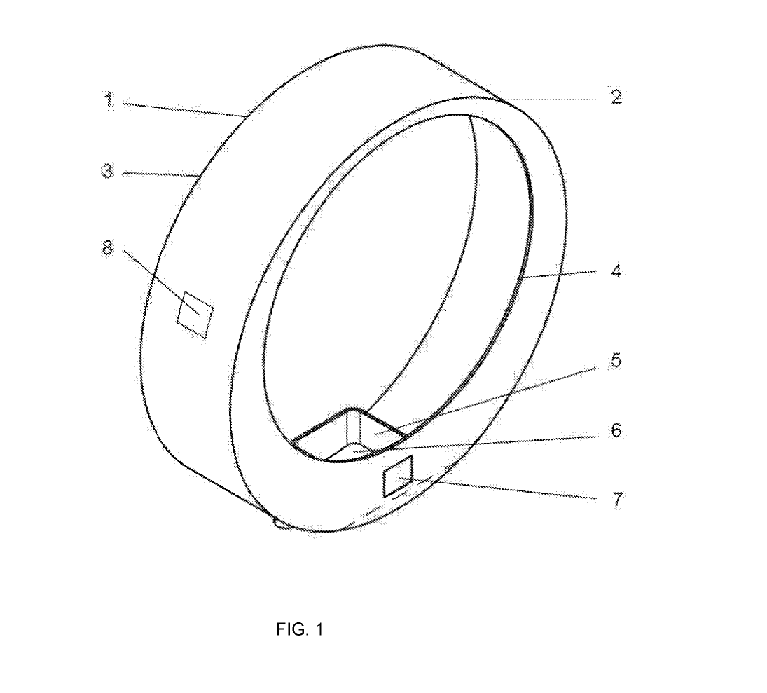

FIG. 1 characterizes, respectively, the box, being that item “1” the external body of the box, in item “2” the front of the acoustic box, in item “3” the back part of the box, in item “4” the opening for the sound to get out, in item “5” an optional compartment to store an amplifier module, in item “6” we see the lowermost internal part of the box which is supported by a surface and is this part where the sound generating equipment is supported, in item “7” a pre-existing opening (optional) for storing the controls, outlets, pins, and connections for pendrives, in the item 8 also a pre existing opening (optional) for support of controls, outlets, pins, slot for pen drives.

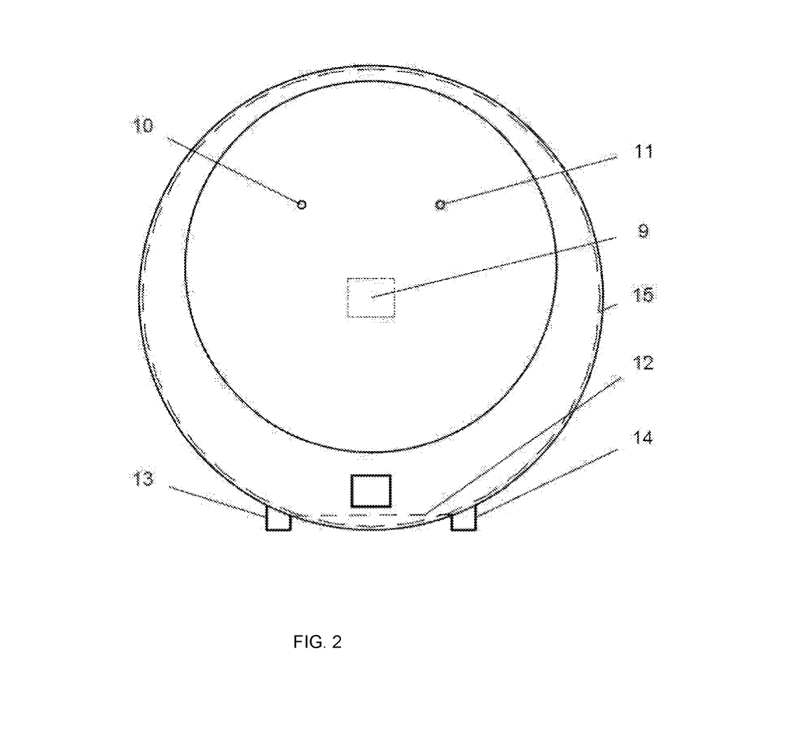

Characterized respectively in FIG. 2, the box is presented, being that item “9” is a pre-existing opening analogous to the openings for the controls, outlets, pins and connections for the pendrives, in item “10” there is a hole to hang or screw to the wall, in item “11” a hole to hang or screw to the wall, in item “12” an option for a straight section on the underside of the round box for better stability together with the support surface, in item “13” a support stand, in item “14” a support stand, in “15” the round box.

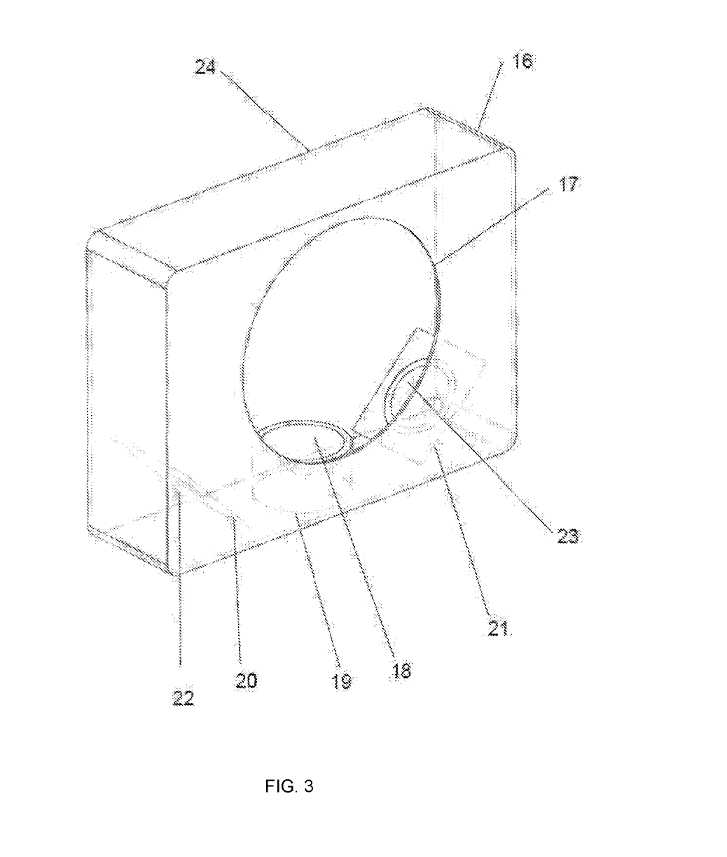

Characterized respectively in FIG. 3 the box is presented with optional equipment being that item “16” on the side of the box which needs to remain up, in item “17” a hole through which sound should exit, in item “18” a speaker or subwoofer (optional), in item “19” and amplifier module or receiver (optional), in item “20” speaker support, in item “21” the support for positioning the speaker, in item “22” a speaker for sound propagation (optional), in item “23” speaker for sound propagation (optional), in item “24” the back side of the box.

Following is a detailing of the schematic figures from the realization of the invention patent, whose dimensions and proportions are not necessarily actual size, since the images have the purpose of presenting in a didactic manner, the diverse aspects of the object, we have in the schematic drawings, various views of the design with the stated purpose of demonstrating the metallic structure and mounting of the equipment:

FIG. 1 shows the box with a semi-lateral view, allowing for internal viewing.

FIG. 2 shows the box from a front angle allowing you to see the internal component;

FIG. 3 shows the box with a view of the complete invention;

1. “ULTRA-LIGHT, MULTIPURPOSE AND SUSTAINABLE DIRECTIONAL ACOUSTIC BOX” is characterized by being a round, rectangular or elliptical box, made of rigid material or steel sheet, like a Flanders Sheet or something analogous, with an opening for the sound to get out, which does not have its own speaker, which possesses in its interior, a place with or without batteries to recharge electrically, plug or external energy cable and a location to place in its interior, any equipment with speakers and sound generators, such as a radio, cellular phone, sound system, residential and commercial alarms in an easy, quick, interchangeable and independent manner, this way improving the audible sound generated by the sound generating equipment; It is also a round, rectangular or elliptical box, made of metallic sheet, a Flanders or analogous type of sheet, with an opening for the sound to get out, which has its own speaker and amplifier, plugs, outlets, control buttons and a compartment to store and connect specific sound generating equipment, be it a radio, cellular telephone, residential or commercial alarms, sound systems, etc; in this way, forming a unique and portable combination, though the sound generating equipment is easily distinguishable; It can even be a round, rectangular or elliptical box, made of rigid material or steel sheet, like a Flanders Sheet or something analogous, with an opening for the sound to get out, which has an appropriate design, form and construction to allow] the placement of sound generating equipment, speakers and/or an entire acoustic box inside, be it big or small, thusly reverberating the sound directly to the interior; It can even be a round, rectangular or elliptical box, made of rigid material or steel sheet, like a Flanders Sheet or something analogous, with an opening for the sound to get out, which has the appropriate design, form and construction to allow compartments that fit sound generating modules, amplifiers and sound controllers, with or without its own speaker, using the existing speaker in the sound generating equipment; Being as well, a round, rectangular or elliptical box, made of rigid material or steel sheet, like a Flanders Sheet or something analogous, with an opening for the sound to get out, which has the appropriate design, form and construction to allow sound generating equipment and speakers to be placed in its interior, reverberating the sound in its interior and the reverberated sound exiting through a specific opening; And to conclude, it can even be a round, rectangular or elliptical box, made of rigid material or steel sheet, like a Flanders Sheet or something analogous, with an opening for the sound to get out, with the appropriate design, form and construction to allow clean and ecological manufacturing, using the bare minimum of pieces and materials, allowing it to be made with scraps from the automobile and home appliance industries, as well as scraps from the canning industry.
